(19) United States
(12) Patent Application Publication
(10) Pub. No.: US 2019/0236563 A1
(43) Pub. Date: Aug. 1, 2019

(54) DECENTRALIZED STAKING POOL SYSTEM OF OPERATION

(71) Applicant: James Tan, Singapore (SG)

(72) Inventor: James Tan, Singapore (SG)

(21) Appl. No.: 15/881,775

(22) Filed: Jan. 28, 2018

(51) Int. Cl. G06Q 20/06; H04L 29/06; G06Q 20/38

(52) U.S. Cl. CPC G06Q 20/0658; H04L 63/0442; G06Q 2220/00; H04L 63/0272; G06Q 20/3829; H04L 63/061

(57) ABSTRACT

In this disclosure, a method for the system of operation of a decentralized staking pool within a proof-of-stake cryptocurrency framework is presented. Stakeholders of a staking pool do not send their stakes to the staking pool. Instead, their association with the staking pool is validated and recorded by other nodes in the cryptocurrency network. Stakeholders who cannot afford expensive computing infrastructure may still participate via the staking pool in a high-throughput and dense network capable of processing tens of thousands of transactions per second with fast transaction confirmation times not limited by long message relay times over a broad and sparse network. After a staking pool has been accepted into the network, it may start validating transactions and participating in the consensus of the distributed ledger, with regular updates of its list of stakeholders to the network, as well as the crediting of transaction fees to its stakeholders.

### FIELD OF THE INVENTION

The invention pertains to cryptocurrencies, more specifically, the invention pertains to the method of operation of a decentralized staking pool within a proof-of-stake cryptocurrency framework.

### BACKGROUND OF THE INVENTION

The invention of the blockchain by Satoshi Nakomoto gave birth to the first cryptocurrency: Bitcoin. Instead of relying and trusting a central authority to clear monetary transactions between parties, trustless transaction validation and consensus on the ledger is now achieved in a decentralized and distributed fashion across the entire Bitcoin network.

The process of achieving consensus in Bitcoin is done by trusting the blockchain (which serves as the ledger) with the most amount of computing power put into it. Such a scheme is known as Proof-of-Work (PoW) which has been criticized for the amount of electricity needed for it. Hence, PoW is not only expensive, but wasteful of energy resources. Another alternative scheme is Proof-of-Stake (PoS) where consensus is achieved by agents whose influences scale positively with their respective stakes in the cryptocurrency.

Typically, in both PoS or PoW schemes, validation of all transactions and the consensus on the ledger is done by each and every member of a group of nodes in a network leading to the decentralized and distributed nature of the system. Because of this, the ledger is also called a distributed ledger. Typically, there is usually little to no restrictions on agents who want to join the network to contribute to the transaction validation and consensus process of the system. While this means that any agent with a working computer and an average connection can join the network, the entire system will be limited to processing several transactions a second. Increasing the number of transactions that the network can process will force out users who cannot afford to invest in expensive computing infrastructure such as computer clusters, networking equipment, and a high bandwidth connection from an internet service provider.

In a cryptocurrency relying on a PoS scheme that wishes to scale in the number of transactions that the network is able to process, the exclusion of agents (henceforth referred to as stakeholders) who cannot afford the computing infrastructure necessary to contribute to the validation of transactions and the consensus of the ledger also excludes them from collecting transaction fees relating to this work.

In order to allow stakeholders who cannot afford the computing infrastructure necessary to participate in a scalable PoS cryptocurrency, a method for the secure operation of a staking pool is presented. A staking pool is an entity that holds or is assigned stakes from multiple stakeholders. In a naive implementation of a staking pool, stakeholders send their stakes to an individual or organization in control of a staking pool which would leverage its sufficient computing and bandwidth infrastructure to participate in the transaction validation and ledger consensus process in the high-throughput cryptocurrency system where tens of thousands of transactions can be validated and processed per second. In return, stakeholders are charged a fee for the maintenance and operation of the computing infrastructure. This fee is presumably less than the profit to be gained from transaction fees allocated due to a stakeholder's stake. The centralized control of the stakes of the staking pool's stakeholders requires immense trust on the part of the stakeholders in the competency and integrity of the operators of the staking pool.

### SUMMARY OF THE INVENTION

To avoid the problem of having to place such a high level of trust in the operators of a staking pool, an invention relating to a method for the operation of a decentralized staking pool is presented.

In the decentralized staking pool, stakeholders do not send their stakes to the staking pool and therefore, are in control of their stakes at all times. The association between the staking pool and the stakeholders is established with consent by both parties. This association is validated and recorded by all nodes that are participating in transaction validations and in the ledger consensus in the network (henceforth known as consensus nodes). A consensus node may be an individual computer or a collection of computing devices that communicates as a single entity and node with the rest of the network and which also participates in transaction validations and in the ledger consensus in the network. Henceforth, the term cryptocurrency network or network shall refer to the network of consensus nodes unless otherwise specified. The staking pool in this framework refers to the computer or computing network that is participating as a consensus node representing its plurality of stakeholders in the cryptocurrency network.

In an epoch, transactions are validated by the staking pool and all other consensus nodes in the network (which may include other staking pools). Before closing an epoch, consensus on the distributed ledger is reached by the consensus nodes whereupon the epoch ends. Transaction fees are accorded to all stakeholders that have participated in the transaction validation and ledger consensus process. The list of the staking pool's stakeholders may also be updated with the rest of the network.

### BRIEF DESCRIPTION OF THE DRAWINGS

FIG. 1 is an example of a cryptocurrency network; and

FIG. 2 is a flowchart of the process of operation for the staking pool.

It should be noted that the figures contained herein illustrate various embodiments of the invention. One skilled in the art may come up with alternative embodiments that do not depart from the principles of the invention presented.

### DETAILED DESCRIPTION OF AN EXAMPLE EMBODIMENT

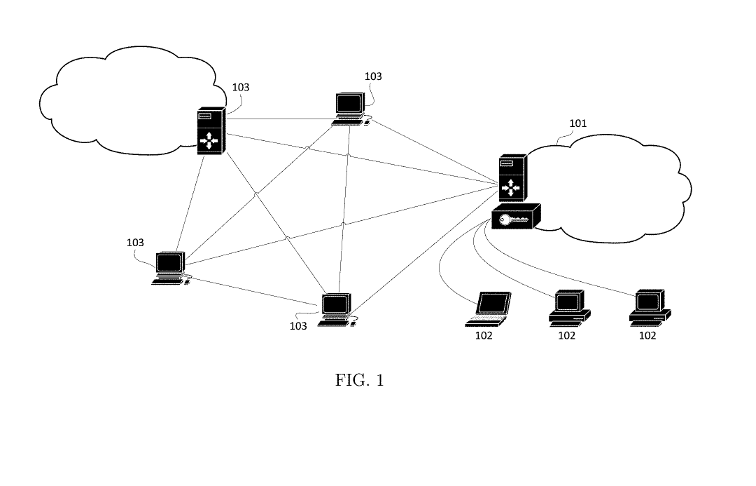

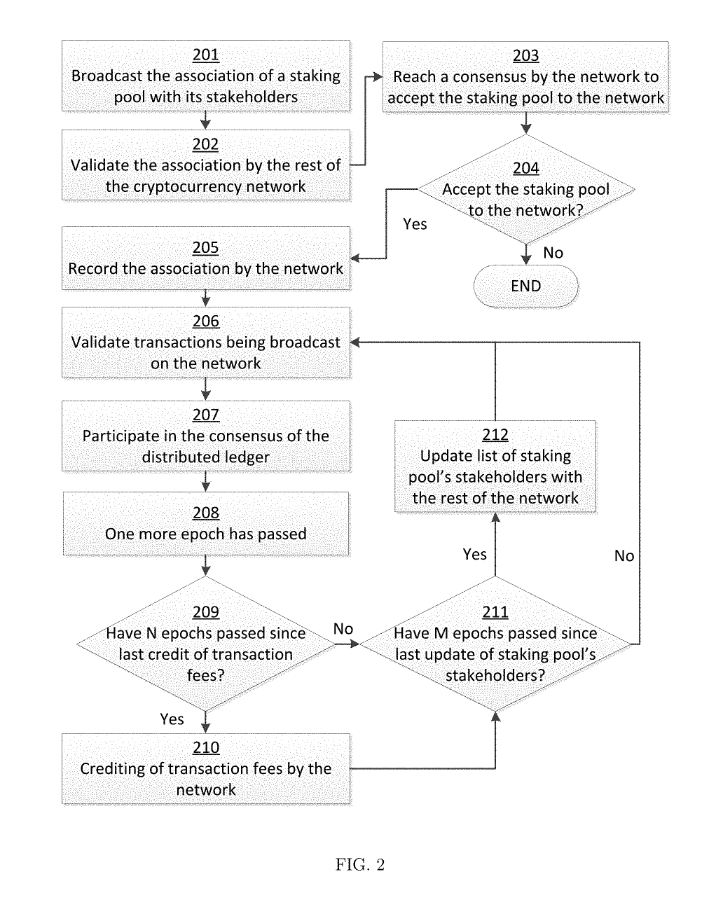

A detailed description of an example embodiment of the present invention is given hereinafter with reference to FIG. 1 and FIG. 2.

FIG. 1. shows a network diagram of an example embodiment of a PoS crytocurrency network. The cryptocurrency network consists of a staking pool 101 and four other consensus nodes 103 connected in a fully connected mesh configuration over the internet. These other consensus nodes 103 may represent individual computers, computer clusters, or other staking pools. The staking pool's stakeholders 102 are connected to the computing network of the staking pool 101 via a virtual private network (VPN) with read-only access to the staking pool's network.

The fully connected mesh configuration of the cryptocurrency network ensures that messages can be delivered to and shared with all consensus nodes in the network (101 and 103) in as little time as possible. Furthermore, the fully-connected topology is resilient such that a failure of any consensus node does not affect the connections between other consensus nodes in the network. The fully-connected topology comes at the expense of the number of connections needed to maintain the fully-connected network topology as the number of connections grows quadratically with the number of consensus nodes in the network. Hence, the consensus nodes in the network are expected to have the necessary computing infrastructure to cope with data that is being transferred over the network.

Stakeholders 102 that do not possess the computing infrastructure necessary to participate in a high-throughput crytocurrency network may still be involved via the staking pool 101 which possesses the necessary computing infrastructure. With read-only access to the staking pool, they can monitor and ensure the correct operation and integrity of the staking pool. The operation of the staking pool can thus be made to be highly secure, with only a few system administrators of the staking pool being granted root access to the staking pool. Furthermore, online network traffic is only limited to the read-only access from the stakeholders of the staking pool, transactional and other crytocurrency data to and from the other nodes 103, and transactional data from other cryptocurrency users wishing to make a transaction. If the stakeholders 102 of the staking pool 101 believes that the integrity of the staking pool 101 has been compromised, they may further communicate their concerns to the rest of the network 103. The other consensus nodes 103 may, upon reviewing evidence, arrive at a consensus to evict the staking pool 101 from the network. Stakeholders may then join another staking pool that still has a presence in the cryptocurrency network.

In the cryptocurrency network, messages relating to the operation of the cryptocurrency such as transactional data, ledger consensus, etc. are transferred between consensus nodes and may be authenticated with digital signatures under a public key cryptography scheme. While it will be necessary to validate the authenticity of the messages for certain operations such as in the consensus of the distributed ledger with a Byzantine Fault Tolerant (BFT) algorithm, it is not necessary for other messages such as the broadcast of transactional data to be signed by the originating consensus node (obviously, the transaction message must still contain a signature corresponding to the cryptocurrency address of the party sending the cryptocurrency in the transaction).

FIG. 2. shows the process of operation of the staking pool in the form of a flow chart. When the staking pool 101 first joins the cryptocurrency network 103, it must broadcast 201 the association between itself and its stakeholders 102 to the rest of the network 103. The stakeholders 102 of the staking pool 101 are identified by their respective cryptocurrency addresses. In this broadcast message, the stakeholders 102 must consent to this association. Hence, this broadcast message must also contain digital signatures corresponding to the stakeholders' 102 cryptocurrency addresses. The stakeholders' 102 consent to this association may be in the form of an authorization of a public key whose secret key is held by the staking pool 101. This allows the rest of the network 103 to authenticate messages from the staking pool 101 in cases where there is a need to leverage the stakes across the network to come at a network-wide (101 and 103) decision such as in the case of the consensus of the distributed ledger. The staking pool must also consent to the association. Hence, the broadcast message must also be signed by the staking pool using its secret-public key pair. Other consensus nodes that join the network but are not staking pools can either use the secret-public key pair associated with their cryptocurrency address when signing messages or authorize another public key from another pair of keys using the secret key corresponding to their cryptocurrency address when they join the network.

After the broadcast 201, the rest of the network 103 will then validate 202 the association between the staking pool 101 and its stakeholders 102. This validation must also include the verification that the stakeholders 102 are not involved in the network as a consensus node nor as a stakeholder associated with another staking pool in the network. Once the rest of the network 103 has validated the association 202, they must then reach a consensus 203 to allow the staking pool 101 to join the network. The consensus can be reached via a BFT algorithm. Dissenting consensus nodes may occur if there is a problem with the validation for example. After the network 103 has accepted the staking pool 101 to the network 103, each and every consensus node (101 and 103) will record the association between the staking pool 101 and its stakeholders 102 and also decide on the epoch that the staking pool 101 will start participating in. The starting epoch can, for example, be defaulted to the next epoch or the epoch following the next epoch.

At the starting epoch, the staking pool 101 will begin validating the transactions 206 that are being broadcast over the network (101 and 103). Cryptocurrency users may also send their transactions to the staking pool 101 and the staking pool 101 will have to validate and broadcast these transactions over the network. Before the close of an epoch, the staking pool 101 will participate 207 in the consensus of the distributed ledger with the other consensus nodes via a BFT algorithm. After consensus has been reached the current epoch concludes and another epoch begins, transactions are validated 206, and the cycle begins anew.

Transaction fees may be credited to all stakeholders involved in the validation of transactions and the ledger consensus process after N epochs (209 and 210), where N is a constant and a positive integer. This means for N≠1, each consensus node in the network will have to keep track of the stakeholders that have been participating in the transaction validation and ledger consensus process for each epoch between the credit of transaction fees.

The staking pool 101 may also update the rest of the network 103 on changes to its list of stakeholders after M epochs (211 and 212), where M is a constant and a positive integer. If a stakeholder is removed from the staking pool 101, it is not necessary for the stakeholder to sign any message authorizing the removal. However, any stakeholder that is added will have to consent to the inclusion which means signing a message with the secret key corresponding to the stakeholder's cryptocurrency address authorizing the stakeholder's addition to the staking pool 101 identified by its public key. This message will be included in the broadcast by the staking pool 101 to the rest of the network 103 on the update. Furthermore, the broadcast by the staking pool 101 must be signed by its secret key so as to allow the other consensus nodes to authenticate the message. For M epochs between each update, the association between the staking pool 101 and its stakeholders cannot change since the record of association that is with the rest of the network 103 remains unchanged. Transaction fees for each epoch between each update will thus be credited 210 based upon the unchanged list of stakeholders belonging to the staking pool 101.

What is claimed:

1. A method for the operation of a staking pool comprising the steps of:
a) broadcasting, by the staking pool, to all other consensus nodes in the cryptocurrency network on the association of the staking pool with its plurality of stakeholders
b) validating, by all other consensus nodes in the cryptocurrency network, the association of the plurality of stakeholders with the staking pool, with each association between a stakeholder and the staking pool involving consent from both the stakeholder and the staking pool;
c) reaching a consensus, by all other consensus nodes in the cryptocurrency network, on accepting the staking pool to the network;
d) recording, by all other consensus nodes in the cryptocurrency network, the association of the plurality of stakeholders with the staking pool;
e) validating, by the staking pool, of all or a subset of transactions that have been broadcasted over a part or the whole of the cryptocurrency network over an epoch; and
f) participating, by the staking pool, in the consensus of the distributed ledger by all consensus nodes in the cryptocurrency network whereupon the current epoch concludes and a new epoch begins;
g) returning to step e) for the continued operation of the staking pool in the new epoch.

2. The method of claim 1 further comprising: crediting of transaction fees, if any, on the distributed ledger to all stakeholders that have participated in the epoch including the stakeholders of the staking pool by all consensus nodes in the cryptocurrency network at any time after an epoch.

3. The method of claim 2 further comprising: updating of changes, if any, in the association the staking pool and its stakeholders with the rest of the cryptocurrency network by one or more broadcasts from the staking pool to the rest of the network at any time after an epoch.

4. The method of claim 3 wherein a consensus node in the cryptocurrency network is any collection of computing devices (staking pool, individual computer, computing cluster, or otherwise) that communicates as a single entity and node in the cryptocurrency network and which also participates in the validation of transactions and in the consensus of the distributed ledger.

5. The method of claim 4 wherein the validation of the association, by the rest of the network, between the staking pool and its stakeholders must also include the verification that any stakeholder of the staking pool is not a part of the network as a consensus node nor as a stakeholder associated with another staking pool in the network, or in the case where only part of a stake belonging to a stakeholder is associated with the staking pool, that the verification must involve checking that the total amount that is being staked by the stakeholder across the network (that is, the total stake of the stakeholder that is involved in cryptocurrency operations such as in the consensus of the ledger) in addition to the amount that is going to be staked with the staking pool does not exceed the total stake that is in the possession of the stakeholder.

6. The method of claim 5 wherein the consent of a stakeholder being associated with a staking pool occurs via cryptographically signed messages from each stakeholder with the cryptographic signature corresponding to the stakeholder's respective cryptocurrency address containing the stakeholder's stake.

7. The method of claim 6 wherein the staking pool is identified by the rest of the network by a public key corresponding to a secret key held in secret by the staking pool from all others who are not involved in the operation of the computing infrastructure of the staking pool which may include all, a subset, or a null set of the staking pool's stakeholders.

8. The method of claim 7 wherein the staking pool uses its secret-public key pair in signing messages when taking part in the consensus of the distributed ledger.

9. The method of claim 8 wherein stakeholders of the staking pool consent to being associated with the staking pool by authorizing the staking pool's public key.

10. The method of claim 9 wherein broadcasts, by the staking pool, of the association between the staking pool and its stakeholders are cryptographically signed using the secret-public key pair held by the staking pool.
